(19) United States
(12) Patent Application Publication
(10) Pub. No.: US 2008/0030029 A1
(43) Pub. Date: Feb. 7, 2008

(54) Double hung entry door bracing system

(76) Inventor: Glenn M. McGinnis, Lutz, FL (US)

Correspondence Address: GLENN M. MCGINNIS, 4902 MIRABELLA PLACE, LUTZ, FL, 33558, US

(21) Appl. No.: 11/804,735

(22) Filed: May 21, 2007

Related U.S. Application Data
(60) Provisional application No. 60/814,300, filed on Jun. 19, 2006.

(51) Int. Cl. E05C 17/40

(52) U.S. Cl. 292/259 R

(57) ABSTRACT

A door bracing system comprising hinge mounted brackets, a method of attachment for the said brackets, a crossbar and a method of locking said crossbar is disclosed.

### RELATED APPLICATIONS

This application claims priority to U.S. Provisional Application No. 60/814,300 which was filed on Jun. 19, 2006.

### BACKGROUND OF THE INVENTION

1. Field of the Invention

The present invention relates to a double hung entry door bracing system and more particularly pertains to mounting bracket assemblies, crossbars and wedging devices for temporary or permanent use when protection from winds or forced entry is required and removing them when no longer needed.

2. Description of the Prior Art

Building codes have been modified a multitude of times to better enable double hung entry doors to resist high winds. One major change has been to mandate that double hung doors open outward. While this is a partial resolution it has became evident that outward opening doors can be sucked open by the high vacuum that forms on the lee side of a home experiencing extreme winds. While many examples of prior art have been proposed as solutions, double hung entry doors continue to be a point of failure for structures that often leads to their total loss.

Double hung entry doors have also been identified as a weak point in a structure from the security perspective in that the center of the opening where the closed doors abut has no building structure for support and the strength of the junction depends upon the door lock itself and any additional locking pins that may be added to lock the stationary door to the floor or top door frame.

A previous art form includes a door brace as evidenced, by U.S. Pat. No. 7,030,758 issued Apr. 18, 2006 to Markegard et al. The present invention offers the ability to use multiple braces by attaching a bracing system to a multitude of opposing hinge pairs and therefore offers more anchor points for door restraint. It addition the present invention will restrain a double hung entry door even after a door lock failure, as the crossbars restrain both doors even when the door lock and top and bottom latch pins are compromised.

Therefore, it can be appreciated that there exists a continuing need for a new and improved removable double hung entry door bracing system that is capable of bracing the door at a multitude of points and that can be easily installed when needed without tools or structure modifications and easily removed following its use. In this regard, the present invention substantially fulfills this need.

### SUMMARY OF THE INVENTION

In view of the disadvantages inherent in the known types of bracing assemblies of known designs and configurations now present in the prior art, the present invention provides an improved double hung entry door bracing system. As such, the general purpose of the present invention, which will be described subsequently in greater detail, is to provide a new and improved double hung entry door bracing system.

To attain this, the present invention essentially comprises brackets which are attached to the existing hinge plates by using longer hinge pivot pins, a crossbar that spans the width of the door and penetrates the openings within the brackets and a wedge mechanism that is used to ensure that the crossbar and the doors are firmly engaged to eliminate motion of the doors.

When the present invention is not in use, the brackets may be left in place or they can be easily removed, and the original hinge pins re-installed. This allows restoration of the appearance of an entryway to the original state prior to use of the present invention.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including such equivalent constructions insofar as they do not depart from the spirit and scope of the present invention.

It is an object of the present invention to provide a new and improved double hung entry door brace which may be easily and efficiently manufactured and marketed.

It is a further object of the present invention to provide an easily installed and removable double hung entry door brace which is of durable and reliable construction.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an isometric drawing illustrating bracket components of the primary embodiment of the invention.

FIG. 2 is an isometric drawing illustrating the assembly of the bracket components of FIG. 1.

FIG. 3 is an isometric drawing of the bracket assembly of FIG. 2 attached to a door hinge.

FIG. 4 is an isometric drawing showing installation of the brace system on a set of double doors.

FIG. 5 is an isometric drawing of the installation of FIG. 4 with obstacles.

FIG. 6A is an isometric drawing of the installation of FIG. 4 with an optional aspect of the invention.

FIG. 6B is a top cross sectional view of FIG. 6A.

FIG. 7 is an isometric drawing of the optional aspect of FIG. 6A.

FIG. 8 is an isometric view of the use of the optional aspect of FIG. 6A.

FIG. 9 is an isometric view of another exemplary embodiment of the present invention.

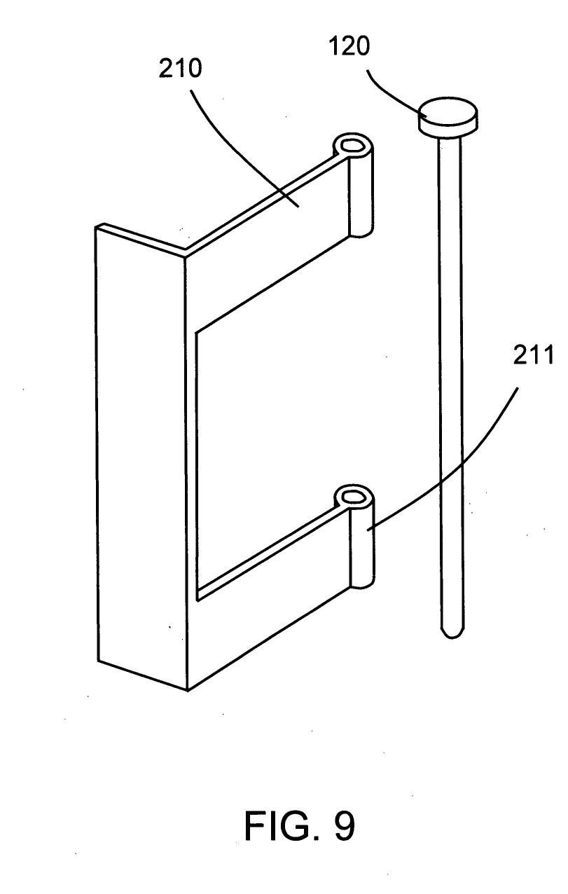

### DETAILED DESCRIPTION OF THE PREFERRED EMBODIMENT

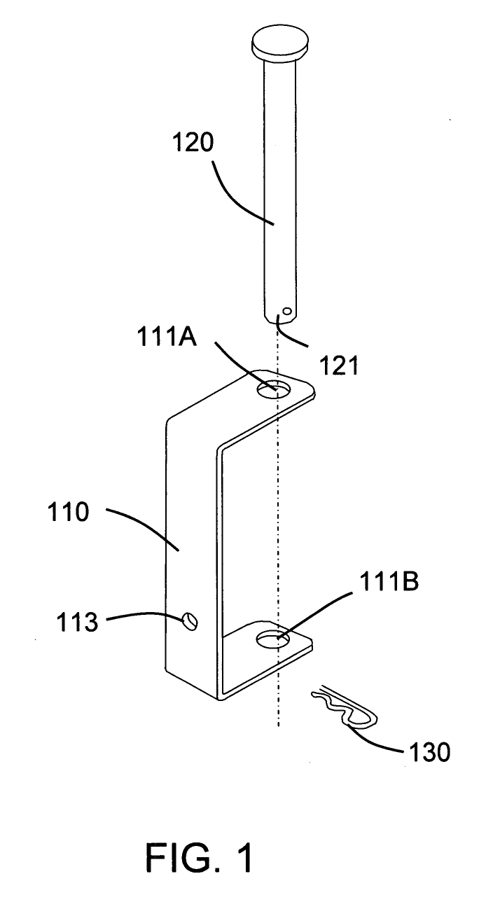

With reference now to the drawings, and in particular to FIG. 1 thereof, the preferred embodiment of the new and improved bracket assembly which is a major component of the double hung entry door brace.

FIG. 1 illustrates the hinge bracket 110. The bracket contains two hinge pin holes 111A and 111B. An additional hole 113 can be utilized to lock the bracket 110 to a crossbar. The bracket hinge pin 120 contains a hole 121 suitable for the insertion of a cotter pin 130 to ensure the bracket hinge pin 120 remains in place.

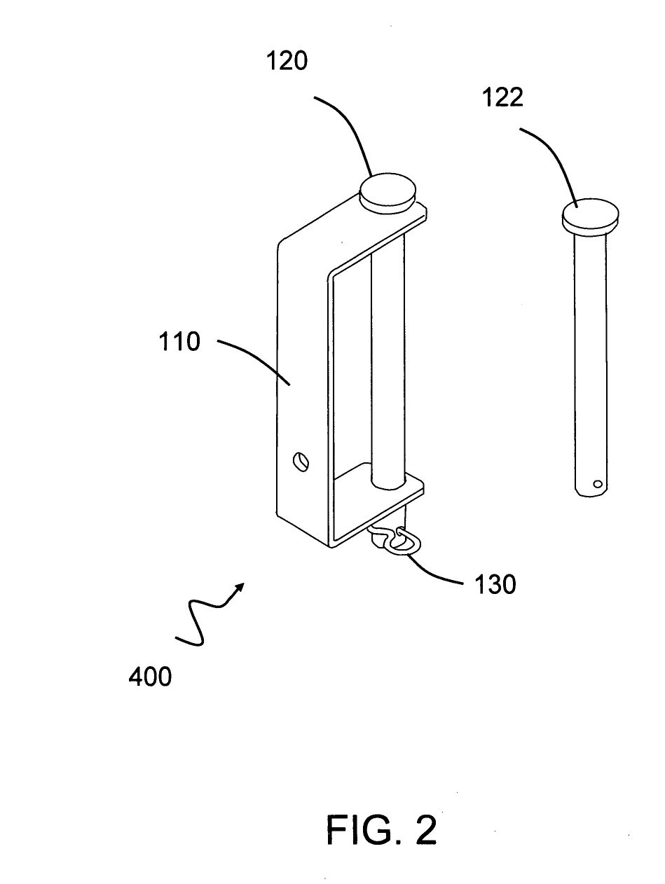

FIG. 2 is an isometric drawing that depicts the complete hinge bracket assembly 400 comprised of a hinge bracket 110 a bracket hinge pin 120 and the cotter pin 130. Also shown is a hitch pin 122 that can be used as an alternative to the combination of the bracket hinge pin 120 and the cotter pin 130.

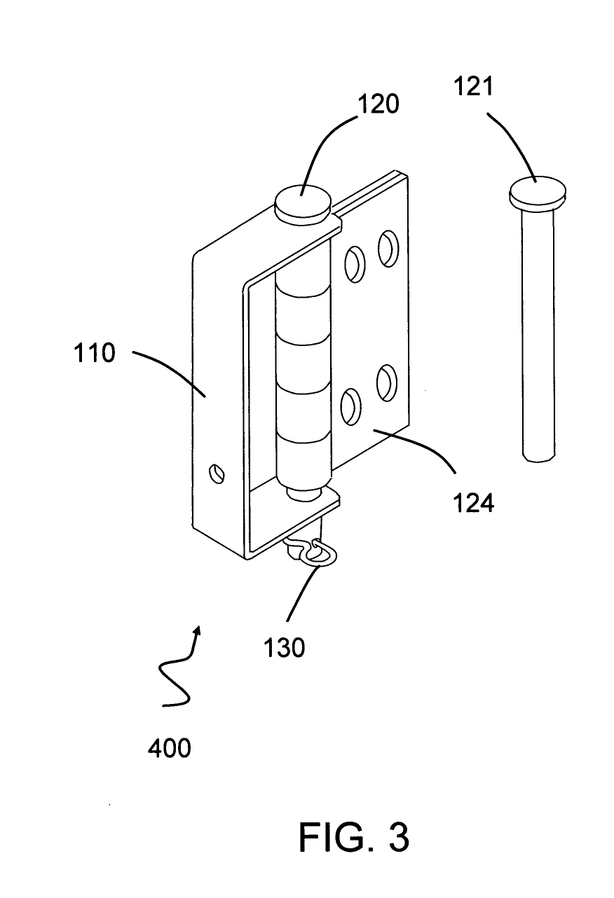

FIG. 3 illustrates the attachment of a hinge bracket assembly 400 to a door hinge 124. Installation of the hinge bracket assemble 400 is accomplished by removing the original hinge pin 121 from a pair of hinge plates 124 one being attached to a door and the other to the door frame. The lengthened hinge pin 120 is inserted thru the top hole of the bracket 110 and then inserted thru the hinge pin opening within the joined pair of hinge plates 124 and then thru the bottom hole of the bracket 110. The cotter pin 130 can then be inserted into the hinge pin 120 in order to ensure it cannot be accidentally removed.

The size and shape of the hinge bracket 110 can be varied to allow the containment of various sizes of lumber or other crossbar materials such as extruded Aluminum.

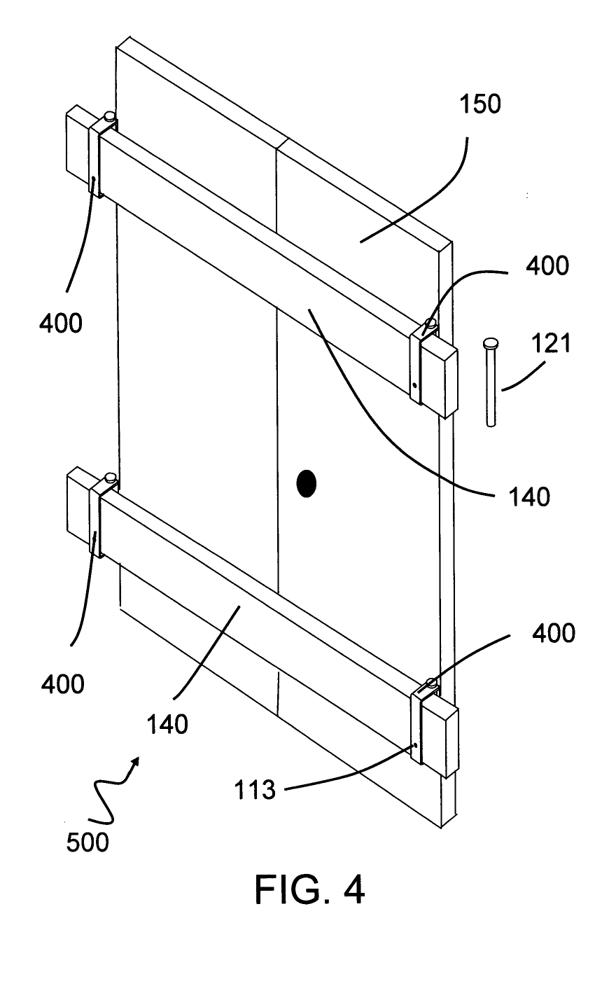

FIG. 4 is an isometric drawing of the double hung entry door bracing system 500. The double hung entry door bracing system 500 consists of two or more hinge bracket assemblies 400 and one crossbar 140 per pair of assemblies.

This drawing depicts the inside of a double hung door 150 showing the doors in a closed position with four hinge bracket assemblies 400 installed. The procedure to install the bracket assemblies 400 would be to pull one original hinge pin 121 at a time and install the bracket assembly 400 in order to ensure that a door does not become dislodged from its closed position during the installation. Following the installation of the hinge bracket assemblies 400 the crossbars 140 can be slid into position. The crossbars 140 can be locked into place by inserting a screw fastener into the bracket hole 113 and engaging it into the crossbar 140.

The double hung entry door bracing system 500 can be used on the inside of inward opening double hung doors 150 for security as well as wind mitigation. It can also be installed on the outside of outward opening double hung doors 150 for wind mitigation purposes.

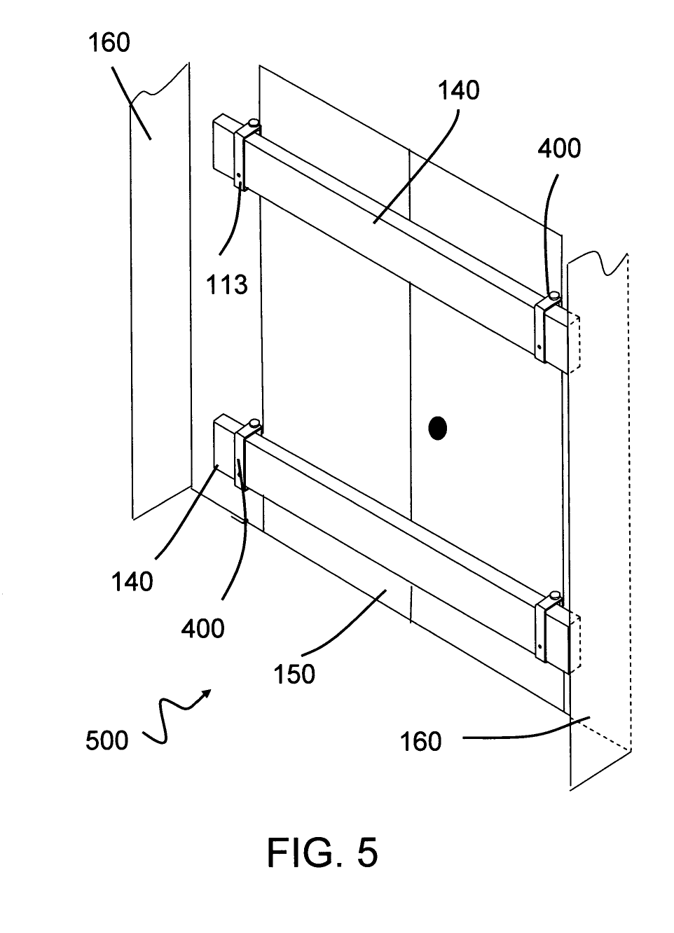

FIG. 5 differs from FIG. 4 as it shows a somewhat different installation of a double hung entry door bracing system 500 on a pair of double hung entry doors 150. Nearby walls 160 that are perpendicular to the plane of the doors 150 make it impossible to slide the crossbars 140 into position from the side. Installation in this scenario would differ in that the installer would be instructed to put one of the two hinge bracket assemblies 400 into place, insert one end of the crossbar 140 into the hinge bracket assembly 400 then move the opposing end of the crossbar 140 into place with a hinge bracket assembly 400 mounted on the crossbar 140, and then install the hinge bracket assembly 400.

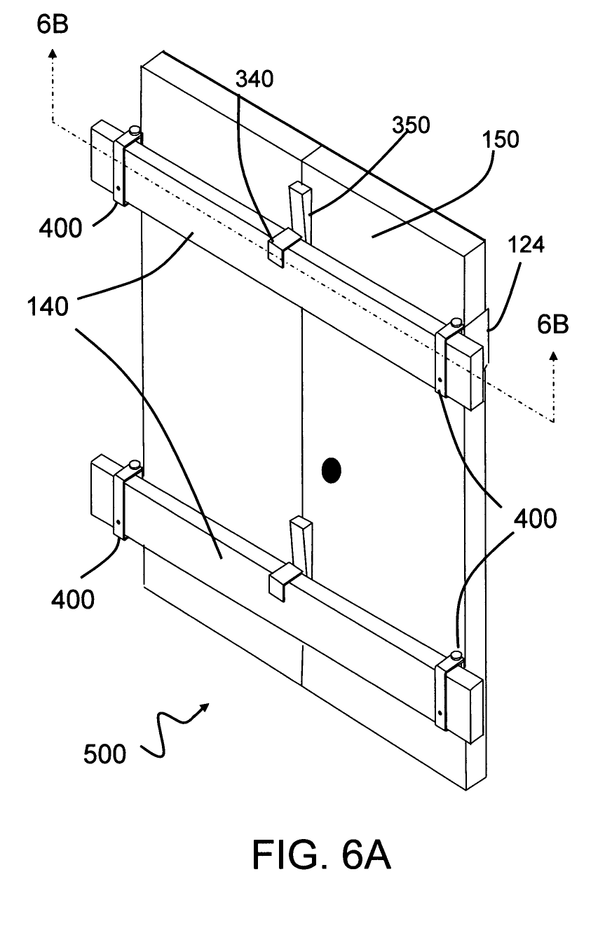

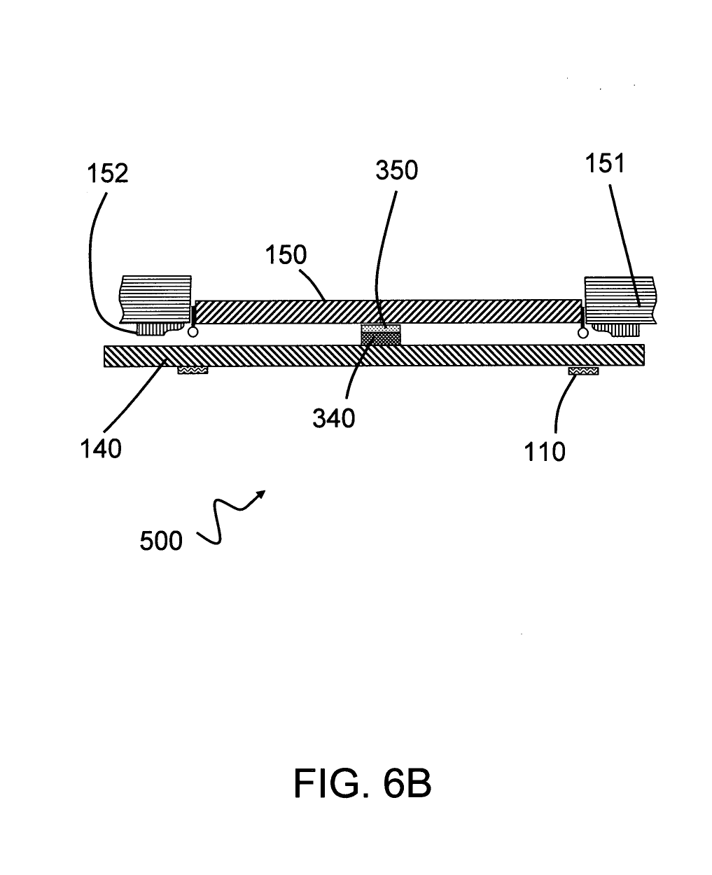

FIG. 6A is an isometric view of an optional aspect of the embodiment 500. The most critical function of the double hung entry door brace 500 is to ensure that neither door is allowed to open when the crossbars 140 are in place. The hinge bracket assemblies 400 and the crossbars 140 provide a sturdy structure that is capable of resisting door movement but a gap exists between the inner surface of the crossbar 140 and the doors 150 based upon the bracket assemblies 400 relationships to the installed hinge plates 124 which extend beyond the doors 150 surface.

FIG. 6B is a top cross sectional view of embodiment 500 shown in FIG. 6A with the addition of walls 151 and door casings 152. The crossbar 140 must stand off from the inner surface of the doors 150 in order to provide space for the door casings 152 and hinge plates 124. The bracket 110 has sufficient depth to allow a crossbar to be inserted while providing the necessary clearance. The crossbar 140 may be made of wood or metal as desired.

Two additional components of this art are used to fill the void existing between the door surface (150) and the crossbar (140). These items are a wedge (350) and a hanging wedge (340) which are emplaced between the crossbar (140) and the door surface (150).

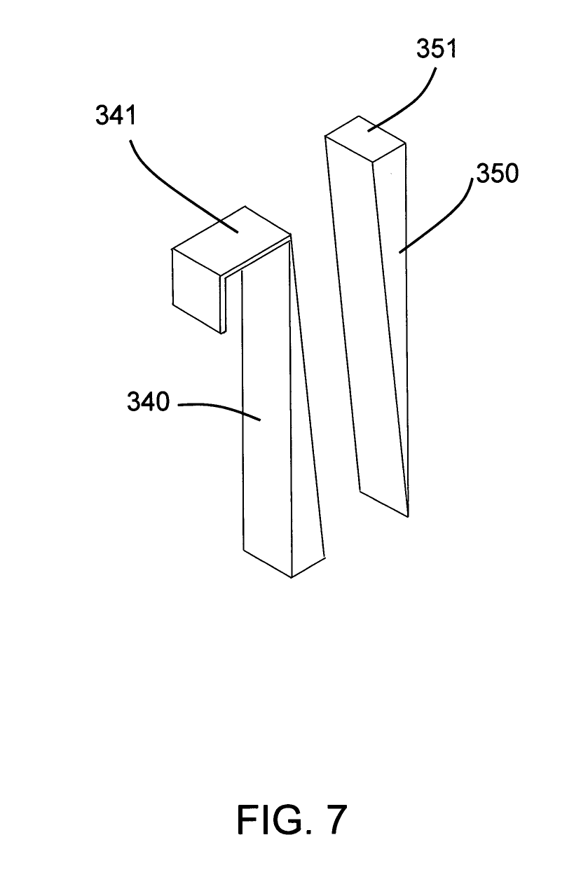

FIG. 7 is an isometric drawing illustrating the wedge (350) and the hanging wedge (340). When the 2 wedges (340 and 350) are joined with the top surfaces 341 and 351 in alignment the thickness of the wedge is the same as the maximum thickness of either of the wedge sections 340 and 350. Moving the wedge 350 down in relation to the hanging wedge 340 causes the overall thickness of the wedges to increase and expand to equal the gap between the doors 150 and the crossbar 140.

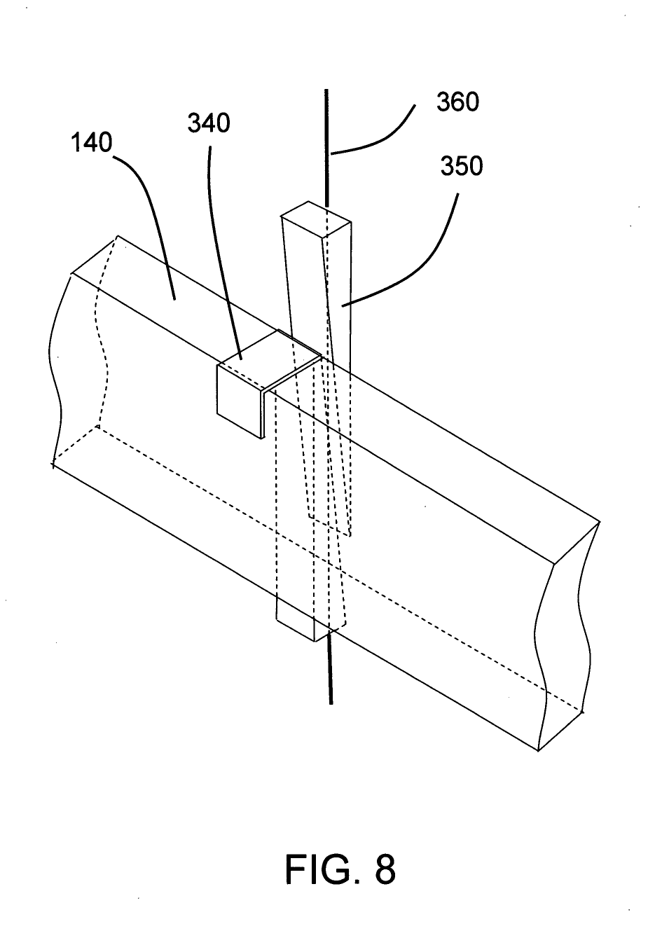

FIG. 8 is an isometric drawing illustrating more detail as to how the wedges 350 and 340 are used. Note that the pair of wedges 340 and 350 are positioned such that the vertical surface of the wedge 350 is placed such that it straddles the juncture of the doors 360 and is firmly wedged against both doors.

FIG. 8 is an isometric view of another exemplary embodiment of the present invention. The narrow hinge bracket 210 allows a wider angle of operation of a door and is better suited to a permanent installation. Narrow hinge bracket mounting tubes 211 provide less obstruction between the juncture of a door and its frame. The same style of bracket hinge pin 120 may be used to attach the narrow hinge bracket 210.

The preceding description has been presented only to illustrate and describe the invention. It is not intended to be exhaustive or to limit the invention to any precise form disclosed. Many modifications and variations are possible in light of the above teaching. The preceding description is intended to enable others skilled in the art to best utilize the invention in various embodiments and with various modifications as are suited to the particular use contemplated. It is intended that the scope of the invention be defined by the following claims.

The devices claimed and described herein may be designed to meet and comply with different standards, building codes and requirements while still being within the state of the art as described herein. The crossbar can be of wood, extruded metal, fiberglass or other materials exhibiting adequate strength. The wedges can be made of wood, plastic or a similar material. The hanger bracket is adhered to the hanging bracket and would be constructed of plastic or metal.

The hinge brackets can be plated or painted to match the color of the hinges to which they are attached.

Moreover, the description and illustration of the invention is by way of example, and the scope of the invention is not limited to the exact details shown or described.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A double hung entry door bracing system comprising:
hinge mounting brackets;
replacement hinge pins used to mount said hinge mounting brackets;
a crossbar; and
a means for retaining the said hinge pins.

2. The system of claim 1, wherein no modifications are performed to the doors or entryway where the system is used.

3. The system of claim 1, wherein the entire system can be installed and removed without tools.

4. The system of claim 1 wherein two wedges are used to lodge the crossbar into position.

5. The system of claim 1 wherein a self retaining hitch pin is used as a replacement hinge pin.

6. The system of claim 1 wherein the hinge mounting brackets are powder coated.

7. The system of claim 1 wherein the hinge mounting brackets are metal plated.

8. The system of claim 1, wherein the system can be applied to one hinge pair or a multitude of hinge pairs to offer variable degrees of security and wind mitigation.

9. The system of claim 1, wherein the system can be applied to the outside of outward opening door pairs to keep the doors from being drawn open by a vacuum caused by high winds.

10. The system of claim 1, wherein the said hinge mounting brackets are reduced in width at the attachment point to provide a wider angle of operation of a door.

11. A method of manufacturing the present invention comprising;
cutting and drilling the hinge pin brackets;
brake bending the hinge pin brackets;
painting or plating the hinge pin brackets;
cutting the wedges to shape; and
cutting the crossbar to length.

12. A method of operating a double hung entry door bracing system comprising;
installing the present hinge bracket assemblies;
inserting the crossbar;
removing the crossbar; and
removing the hinge bracket assemblies.

13. The method of claim 12, wherein the bracing system is installed on the exterior of outward opening double hung entry doors for the purpose of wind mitigation.
